(19) United States
(12) Patent Application Publication
(10) Pub. No.: US 2022/0106465 A1
(43) Pub. Date: Apr. 7, 2022

(54) COMPOSITIONS SUITABLE FOR MANUFACTURING POLYETHYLENE FOAM, AND ARTICLES THEREOF

(71) Applicant: Dow Global Technologies LLC, Midland, MI (US)

(72) Inventors: Yunfeng Yang, Shanghai (CN); Hongyu Chen, Shanghai (CN); Jianping Pan, Shanghai (CN); Bin Li, Shanghai (CN); Lei Ying, Shanghai (CN); Xiaobing Yun, Shanghai (CN); Sheng Li, Shanghai (CN); Jichang Feng, Shanghai (CN)

(21) Appl. No.: 17/049,993

(22) PCT Filed: Jun. 29, 2019
(86) PCT No.: PCT/CN2018/093535

§ 371 Date: Oct. 23, 2020

(51) Int. Cl. C08L 23/06; C08J 9/00

(52) U.S. Cl. CPC C08L 23/06; C08J 2427/18; C08J 2323/06; C08J 9/0061

(57) ABSTRACT

Embodiments of the present disclosure generally relate to compositions suitable for manufacturing polyethylene foam. In one aspect, a composition suitable for making uncrosslinked low density polyethylene foam comprising at least 50 weight percent low density polyethylene based on the total weight of the composition, wherein the low density polyethylene has a density of 0.915 to 0.930 g/cm³ and a melt index (I₂) of 1 to 4 g/10 minutes; and polytetrafluoroethylene having an average particle size of one micron to 15 microns.

### FIELD

Embodiments of the present disclosure generally relate to compositions suitable for manufacturing polyethylene foam, and specifically relate to compositions suitable for manufacturing uncrosslinked low density polyethylene foam, and articles thereof.

### INTRODUCTION

Polyethylene foam materials may be used as protective packaging for electronics, furniture, fruits, among other things. The polyethylene foam materials typically use low density polyethylene (LDPE) in these applications as it has high melt strength necessary for foam cell wall stability. However, LDPE lacks in mechanical properties, such as compressive strength and tear strength, when they are converted into foams, particularly where either heavier objects or an object that is shock sensitive requires protection. In those cases, a thicker and or heavier foam package would have to be used to provide enough protection of the object, which then translates to either higher material cost and/or shipping cost (i.e., bulkier packages cost more to ship).

In addition, for some protective packaging applications, it can be important to have increased thermal insulation.

Accordingly, it would be desirable to have alternative compositions suitable for manufacturing polyethylene foam, which can provide suitable tear strength and/or compressive strength and/or thermal insulation, while also providing a similar level of object protection at a lower weight or a lower package volume, which may translate into material cost and/or shipping cost savings.

### SUMMARY

The present invention provides compositions for making uncrosslinked low density polyethylene foam that, in some aspects, provide foams having desirable compressive strengths and/or thermal insulation properties. In some embodiments, such compositions can provide desirable compressive strengths and/or thermal insulation properties at lower foam densities.

In one aspect, a composition suitable for making uncrosslinked low density polyethylene foam comprises at least 50 weight percent low density polyethylene based on the total weight of the composition, wherein the low density polyethylene has a density of 0.915 to 0.930 g/cm³ and a melt index (I₂) of 1 to 4 g/10 minutes, and polytetrafluoroethylene having an average particle size of one micron to 15 microns.

Some aspects of the present invention relate to uncrosslinked low density polyethylene foam. Uncrosslinked low density polyethylene foams, in some aspects, can be formed from any of the polyethylene compositions disclosed herein as being suitable for making uncrosslinked low density polyethylene foam. In one aspect, an uncrosslinked low density polyethylene foam is formed from a polyethylene composition comprising at least 50 weight percent low density polyethylene based on the total weight of the composition, wherein the low density polyethylene has a density of 0.915 to 0.930 g/cm³ and a melt index (12) of 1 to 4 g/10 minutes, and polytetrafluoroethylene having an average particle size of one micron to 15 microns, wherein the foam density of the polyethylene foam is 15 to 60 kg/m³.

Some aspects of the present invention relate to articles such as packages. In one aspect, a package comprising any of the inventive foams disclosed herein.

These and other embodiments are described in more detail in the Detailed Description.

### DETAILED DESCRIPTION

Unless stated to the contrary, implicit from the context, or customary in the art, all parts and percents are based on weight, all temperatures are in ° C., and all test methods are current as of the filing date of this disclosure.

The term “composition,” as used herein, refers to a mixture of materials which comprises the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or a polymer mixture, including mixtures of polymers that are formed in situ during polymerization.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene/alpha-olefin interpolymer,” as used herein, refers to an interpolymer that comprises, in polymerized form, a majority amount (>50 mol %) of units derived from ethylene monomer, and the remaining units derived from one or more alpha-olefins. The term “alpha-olefin”, as used herein, refers to an alkene having a double bond at the primary or alpha (α) position. Typical alpha-olefins used in forming ethylene/alpha-olefin interpolymers are C₃-C₁₀ alkenes.

The term “in adhering contact” and like terms mean that one facial surface of one layer and one facial surface of another layer are in touching and binding contact to one another such that one layer cannot be removed from the other layer without damage to the interlayer surfaces (i.e., the in-contact facial surfaces) of both layers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

“Polyethylene” or “ethylene-based polymer” shall mean polymers comprising a majority amount (>50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, bis-metallocene catalysts and constrained geometry catalysts, and typically have a molecular weight distribution (“MWD”) greater than 2.5.

The term “HDPE” refers to polyethylenes having densities greater than about 0.935 g/cm³ and up to about 0.970 g/cm³, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cm³, which are generally prepared with Ziegler-Natta catalysts, chrome catalysts, or single-site catalysts including, but not limited to, bis-metallocene catalysts and constrained geometry catalysts.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

Reference will now be made in detail to embodiments of compositions suitable for making uncrosslinked low density polyethylene foam, and to embodiments of uncrosslinked low density polyethylene foams. As used herein, “uncrosslinked” refers to no intentional usage or addition of a crosslinking agent throughout the foaming process. The compositions and/or foams may be used in protective packaging for electronics, furniture, fruits, glass items, toys, among other things, or with any other article where cushioning protection from shock and/or vibration is desired. The compositions and/or foams may also be used in protective packaging for articles where insulation from heat is desired. It is noted, however, that these are merely illustrative implementations of the embodiments disclosed herein. The embodiments may be applicable to other technologies that are susceptible to similar problems as those discussed above and herein. For example, the compositions and/or foams described herein may be used in cushioned mats, cushioned floor pads, as a mattress component, etc., all of which are within the purview of the present embodiments.

In one embodiment, a composition suitable for making uncrosslinked low density polyethylene foam comprises at least 50 weight percent low density polyethylene based on the total weight of the composition, wherein the low density polyethylene has a density of 0.915 to 0.930 g/cm³ and a melt index (I₂) of 1 to 4 g/10 minutes, and polytetrafluoroethylene having an average particle size of one micron to 15 microns.

In some embodiments, the average particle size of the polytetrafluoroethylene is from one to 12 microns. The average particle size of the polytetrafluoroethylene is from five to 12 microns in some embodiments. In some embodiments, the composition comprises 0.01 to 0.2 weight percent of the polytetrafluoroethylene based on the total weight of the composition. The composition comprises, in some embodiments, 0.02 to 0.15 weight percent of the polytetrafluoroethylene based on the total weight of the composition. The composition comprises 0.03 to 0.1 weight percent of the polytetrafluoroethylene based on the total weight of the composition in some embodiments.

In some embodiments, the composition comprising from 5 to less than 50 weight percent ethylene/alpha-olefin interpolymer having a density of 0.910-0.930 g/cm³ based on the total weight of the composition. In some such embodiments, the composition comprises less than 40 weight percent, or less than 30 weight percent, ethylene/alpha-olefin interpolymer having a density of 0.910-0.930 g/cm³ based on the total weight of the composition. In some embodiments, the ethylene/alpha-olefin interpolymer having a density of 0.910-0.930 g/cm³ is a linear low density polyethylene.

In some embodiments, compositions of the present invention further comprise stearyl stearamide, glycerol monostearate, glycerol monobehenate, glycerol distearate, glycerol monobenzoate, sorbitan monooleate, sorbitol monostearate, or a combination thereof. In some such embodiments, such compounds comprise 0.5 to 1.5 weight percent of the composition based on the total weight of the composition.

Embodiments of the present invention also relate to uncrosslinked low density polyethylene foams. In general, an uncrosslinked low density polyethylene foam can be formed from any of the inventive compositions disclosed herein for making uncrosslinked low density polyethylene foams. In one embodiment, an uncrosslinked low density polyethylene foam is formed from a polyethylene composition, the composition comprising at least 50 weight percent low density polyethylene based on the total weight of the composition, wherein the low density polyethylene has a density of 0.915 to 0.930 g/cm³ and a melt index (I₂) of 1 to 4 g/10 minutes, and polytetrafluoroethylene having an average particle size of one micron to 15 microns, wherein the foam density of the polyethylene foam is 15 to 60 kg/m³.

In some embodiments, the foam has an average cell size of 1.2 millimeters (mm) or less.

In some embodiments, the composition used to make the uncrosslinked low density polyethylene foams of the present invention comprising from 5 to less than 50 weight percent ethylene/alpha-olefin interpolymer having a density of 0.910-0.930 g/cm³ based on the total weight of the composition. In some such embodiments, the composition comprises less than 40 weight percent, or less than 30 weight percent, ethylene/alpha-olefin interpolymer having a density of 0.910-0.930 g/cm³ based on the total weight of the composition. In some embodiments, the ethylene/alpha-olefin interpolymer having a density of 0.910-0.930 g/cm³ is a linear low density polyethylene.

In some embodiments, the average particle size of the polytetrafluoroethylene in the composition used to make the uncrosslinked low density polyethylene foams of the present invention is from one to 12 microns. The average particle size of the polytetrafluoroethylene is from five to 12 microns in some embodiments. In some embodiments, the composition comprises 0.01 to 0.2 weight percent of the polytetrafluoroethylene based on the total weight of the composition. The composition comprises, in some embodiments, 0.02 to 0.15 weight percent of the polytetrafluoroethylene based on the total weight of the composition. The composition comprises 0.03 to 0.1 weight percent of the polytetrafluoroethylene based on the total weight of the composition in some embodiments.

In some embodiments, the compositions used to make uncrosslinked low density polyethylene foams of the present invention further comprise stearyl stearamide, glycerol monostearate, glycerol monobehenate, glycerol distearate, glycerol monobenzoate, sorbitan monooleate, sorbitol monostearate, or a combination thereof. In some such embodiments, such compounds comprise 0.5 to 1.5 weight percent of the composition based on the total weight of the composition.

Some embodiments of the present invention also relate to articles such as packages. Such articles or packages can be formed from any of the inventive uncrosslinked low density polyethylene foams disclosed herein. In some embodiments, such articles are packages such as protective packaging for electronics, furniture, fruits, glass items, toys, or other items where cushioning protection from shock and/or vibration is desired. In some embodiments, such articles are cushioned mats, cushioned floor pads, as a mattress component, and others.

### Low Density Polyethylene (LDPE)

The compositions suitable for making uncrosslinked low density polyethylene comprise at least 50 weight percent low density polyethylene based on the total weight of the composition.

The low density polyethylene has a density of from 0.915 g/cm³ to 0.930 g/cm³. The low density polyethylene also has a melt index, or 12, of from 1 g/10 min to 4 g/10 min. All individual values and subranges are included and disclosed herein. For example, in some embodiments, the low density polyethylene may have a density of from 0.917 g/cm³ to 0.930 g/cm³, 0.917 g/cm³ to 0.927 g/cm³, or 0.919 g/cm³ to 0.925 g/cm³, and a melt index from 1 to 3.5 g/10 min or 1 to 3 g/10 min. In other embodiments, the low density polyethylene may have a density of from 0.920 g/cm³ to 0.930 g/cm³, 0.922 g/cm³ to 0.930 g/cm³, or 0.925 g/cm³ to 0.930 g/cm³ and a melt index from 1 to 3.5 g/10 min, 1 to 3 g/10 min, 1 g/10 min to 2.5 g/10 min, 1 g/10 min to 2 g/10 min, or 1 g/10 min to 1.5 g/10 min.

The LDPE may include branched polymers that are partly or entirely homopolymerized or copolymerized in autoclave and/or tubular reactors, or any combination thereof, using any type of reactor or reactor configuration known in the art, at pressures above 14,500 psi (100 MPa) with the use of free-radical initiators, such as peroxides (see for example U.S. Pat. No. 4,599,392, herein incorporated by reference). In some embodiments, the LDPE may be made in an autoclave process under single phase conditions designed to impart high levels of long chain branching, such as described in PCT Patent Publication WO 2005/023912, the disclosure of which is incorporated herein by reference. Examples of suitable LDPEs may include, but are not limited to, ethylene homopolymers. The ethylene may also be interpolymerized with an alpha-olefin comonomer, for example, at least one C3-C20 alpha-olefin, such as propylene, isobutylene, 1-butene, 1-pentene, 1-hexene, and mixtures thereof. Other examples of suitable LDPEs may include, but are not limited to, high pressure copolymers, including ethylene interpolymerized with, for example, vinyl acetate, ethyl acrylate, butyl acrylate, acrylic acid, methacrylic acid, carbon monoxide, or combinations thereof. Exemplary LDPE resins may include, but are not limited to, resins sold by The Dow Chemical Company, such as, LDPE 320E resins, LDPE 352E resins, LDPE 450E resins, or LDPE 582E resins, resins sold by Westlake Chemical Corporation (Houston, Tex.), such as EF412, EF923, EF796, EF606, EF706, or EF413, resins sold by LyondellBasell Industries (Houston, Tex.), such as, MICROTHENE™ MN72200 or PETROTHENE™ M2520FN, NA143063, or NA149000, and resins sold by The ExxonMobil Chemical Company (Houston, Tex.) such as, LDPE LD 136.MN, LD 123.LM, LD 129.24, or LD 160AT. Other exemplary LDPE resins are described in WO 2014/051682 and WO 2011/019563, which are herein incorporated by reference.

### Polytetrafluroethylene

Without wishing to be bound by theory, it is believed that providing the polytetrafluoroethylene, having an average particle size within the ranges and in the amounts disclosed herein, as a nucleating agent (or nucleator) for foaming of low density polyethylene based compositions provides a variety of advantages and unexpected results. Such advantages and results can include, for example, significantly reduced cell size, increased compressive strength at lower foam densities, and increased thermal insulation.

The compositions suitable for making uncrosslinked low density polyethylene foam comprise polytetrafluoroethylene having an average particle size of one to 15 microns. In some embodiments, the average particle size of the polytetrafluoroethylene in the composition used to make the uncrosslinked low density polyethylene foams of the present invention is from one to 12 microns. The average particle size of the polytetrafluoroethylene is from five to 12 microns in some embodiments.

In some embodiments, the composition for making uncrosslinked low density polyethylene foam comprises 0.01 to 0.2 weight percent of the polytetrafluoroethylene based on the total weight of the composition. The composition, in some embodiments, 0.02 to 0.15 weight percent of the polytetrafluoroethylene based on the total weight of the composition. The composition comprises 0.03 to 0.1 weight percent of the polytetrafluoroethylene based on the total weight of the composition in some embodiments.

In some embodiments, the polytetrafluoroethylene has an average particle size of one to 15 microns and comprises 0.01 to 0.2 weight percent of a composition suitable for making uncrosslinked low density polyethylene, based on the total weight of the composition. The polytetrafluoroethylene, in some embodiments, has an average particle size of one to 12 microns and comprises 0.02 to 0.15 weight percent of a composition suitable for making uncrosslinked low density polyethylene, based on the total weight of the composition. In some embodiments, the polytetrafluoroethylene has an average particle size of 5 to 12 microns and comprises 0.03 to 0.1 weight percent of a composition suitable for making uncrosslinked low density polyethylene, based on the total weight of the composition.

One example of a polytetrafluoroethylene that can be used in embodiments of the present invention is AXELERON™ CX 0078 NT, which is commercially available from The Dow Chemical Company. AXELERON™ CX 0078 NT is a masterbatch that includes the polytetrafluoroethylene in a low density polyethylene carrier.

### Ethylene/Alpha-Olefin Interpolymer

In some embodiments, a composition suitable for making uncrosslinked foams can further comprise an ethylene/alpha-olefin interpolymer. In some embodiments, the ethylene/alpha-olefin interpolymer comprises greater than 50 wt. % of the units derived from ethylene and less than 30 wt. % of the units derived from one or more alpha-olefin comonomers (based on the total amount of polymerizable monomers). All individual values and subranges of greater than 50 wt. % of the units derived from ethylene and less than 30 wt. % of the units derived from one or more alpha-olefin comonomers are included and disclosed herein. For example, the ethylene/alpha-olefin polymer may comprise (a) greater than or equal to 55%, for example, greater than or equal to 60%, greater than or equal to 65%, greater than or equal to 70%, greater than or equal to 75%, greater than or equal to 80%, greater than or equal to 85%, greater than or equal to 90%, greater than or equal to 92%, greater than or equal to 95%, greater than or equal to 97%, greater than or equal to 98%, greater than or equal to 99%, greater than or equal to 99.5%, from greater than 50% to 99%, from greater than 50% to 97%, from greater than 50% to 94%, from greater than 50% to 90%, from 70% to 99.5%, from 70% to 99%, from 70% to 97% from 70% to 94%, from 80% to 99.5%, from 80% to 99%, from 80% to 97%, from 80% to 94%, from 80% to 90%, from 85% to 99.5%, from 85% to 99%, from 85% to 97%, from 88% to 99.9%, 88% to 99.7%, from 88% to 99.5%, from 88% to 99%, from 88% to 98%, from 88% to 97%, from 88% to 95%, from 88% to 94%, from 90% to 99.9%, from 90% to 99.5% from 90% to 99%, from 90% to 97%, from 90% to 95%, from 93% to 99.9%, from 93% to 99.5% from 93% to 99%, or from 93% to 97%, by weight, of the units derived from ethylene; and (b) less than 30 percent, for example, less than 25 percent, or less than 20 percent, less than 18%, less than 15%, less than 12%, less than 10%, less than 8%, less than 5%, less than 4%, less than 3%, less than 2%, less than 1%, from 0.1 to 20%, from 0.1 to 15%, 0.1 to 12%, 0.1 to 10%, 0.1 to 8%, 0.1 to 5%, 0.1 to 3%, 0.1 to 2%, 0.5 to 12%, 0.5 to 10%, 0.5 to 8%, 0.5 to 5%, 0.5 to 3%, 0.5 to 2.5%, 1 to 10%, 1 to 8%, 1 to 5%, 1 to 3%, 2 to 10%, 2 to 8%, 2 to 5%, 3.5 to 12%, 3.5 to 10%, 3.5 to 8%, 3.5% to 7%, or 4 to 12%, 4 to 10%, 4 to 8%, or 4 to 7%, by weight, of units derived from one or more α-olefin comonomers. The comonomer content may be measured using any suitable technique, such as techniques based on nuclear magnetic resonance (“NMR”) spectroscopy, and, for example, by 13C NMR analysis as described in U.S. Pat. No. 7,498,282, which is incorporated herein by reference.

Suitable alpha-olefin comonomers typically have no more than 20 carbon atoms. The one or more alpha-olefins may be selected from the group consisting of C3-C20 acetylenically unsaturated monomers and C4-C18 diolefins. For example, the alpha-olefin comonomers may have 3 to 10 carbon atoms, or 3 to 8 carbon atoms. Exemplary alpha-olefin comonomers include, but are not limited to, propylene, 1-butene, 1-pentene, 1-hexene, 1-heptene, 1-octene, 1-nonene, 1-decene, and 4-methyl-1-pentene. The one or more alpha-olefin comonomers may, for example, be selected from the group consisting of propylene, 1-butene, 1-hexene, and 1-octene; or in the alternative, from the group consisting of 1-butene, 1-hexene and 1-octene, or in the alternative, from the group consisting of 1-hexene and 1-octene. In some embodiments, the ethylene/alpha-olefin interpolymer comprises greater than 0 wt. % and less than 30 wt. % of units derived from one or more of 1-octene, 1-hexene, or 1-butene comonomers.

Any conventional ethylene (co)polymerization reaction processes may be employed to produce the ethylene/alpha-olefin interpolymer composition. Such conventional ethylene (co)polymerization reaction processes include, but are not limited to, gas phase polymerization process, slurry phase polymerization process, solution phase polymerization process, and combinations thereof using one or more conventional reactors, e.g. fluidized bed gas phase reactors, loop reactors, stirred tank reactors, batch reactors in parallel, series, and/or any combinations thereof. Additional ethylene (co)polymerization reaction processes may be found in U.S. Pat. Nos. 5,272,236, 5,278,272, 6,812,289, and WO 93/08221, all of which are incorporated herein by reference.

In some embodiments, the ethylene/alpha-olefin interpolymer may comprise a homogeneously branched ethylene/alpha-olefin copolymer component and a heterogeneously branched ethylene/alpha-olefin copolymer component. The homogeneously branched ethylene/alpha-olefin copolymer component may be a random homogeneously branched linear ethylene/α-olefin copolymer component or a random homogeneously branched substantially linear ethylene/α-olefin copolymer component. The term “substantially linear ethylene/α-olefin copolymer” means that the polymer backbone is substituted with from 0.01 long chain branches/1000 carbons to 3 long chain branches/1000 carbons, or from 0.01 long chain branches/1000 carbons to 1 long chain branches/1000 carbons, or from 0.05 long chain branches/1000 carbons to 1 long chain branches/1000 carbons. In contrast, the term “linear ethylene/α-olefin copolymer” means that the polymer backbone has no long chain branching. The homogeneously branched ethylene/α-olefin copolymer component may be produced, for example, using metallocene catalysts. This includes homogeneous-branched, substantially linear ethylene polymers (“SLEP”) which are prepared using constrained geometry catalysts (“CGC Catalyst”), such as disclosed in U.S. Pat. Nos. 5,272,236, 5,278,272, 6,812,289, and WO 93/08221, which are incorporated herein by reference, as well as the homogeneous linear ethylene polymers (“LEP”) which are prepared using other metallocene (called “bis-CP catalysts”). Other catalyst systems that may be used to form the homogeneously branched ethylene/α-olefin copolymer include those comprising a metal complex of a polyvalent aryloxyether, which is further described in U.S. Pat. No. 8,450,438, and is incorporated herein by reference.

The heterogeneously branched ethylene/α-olefin copolymer component differs from the homogeneously branched ethylene/α-olefin copolymer component primarily in their branching distribution. For example, the heterogeneously branched ethylene/α-olefin copolymer component has a distribution of branching that includes a highly branched portion (similar to a very low density polyethylene), a medium branched portion (similar to a medium branched polyethylene) and an essentially linear portion (similar to linear homopolymer polyethylene). The heterogeneously branched ethylene/α-olefin copolymer component can be prepared via the polymerization of ethylene and one or more α-olefin comonomers in the presence of a Ziegler Natta catalyst as disclosed in U.S. Pat. Nos. 4,076,698 and 5,844,045, which are incorporated by reference herein in their entirety. For example and not by way of limitation, these Ziegler-Natta catalysts may include Group 4 metal halides supported on Group 2 metal halides or mixed halides and alkoxides and chromium or vanadium-based catalysts. In specific embodiments, the Ziegler-Natta catalyst composition may be a multi-constituent catalyst system including a magnesium and titanium containing procatalyst and a cocatalyst. The procatalyst may, for example, may comprise the reaction product of magnesium dichloride, an alkylaluminum dihalide, and a titanium alkoxide.

In some embodiments, the ethylene/alpha-olefin interpolymer has a density ranging from 0.910 g/cm³ to 0.930 g/cm³. All individual values and subranges are disclosed and included herein. For example, the ethylene/alpha-olefin interpolymer may have a density ranging from 0.910 g/cm³ to 0.925 g/cm³ or 0.915 g/cm³ to 0.925 g/cm³. In addition to the density, the ethylene/alpha-olefin interpolymer has a melt index (12) may range from 0.5 to 6.0 g/10 min. All individual values and subranges are disclosed and included herein. For example, the ethylene/alpha-olefin interpolymer may have a melt index (I₂) of from 0.5 to 3.0 g/10 minutes, 0.5 to 2.0 g/10 minutes, or 0.5 to 1.4 g/10 minutes.

In addition to density and melt index, the ethylene/alpha-olefin interpolymer has an Mw/Mn of from 2.8 to 4.5, where Mw is the weight average molecular weight and Mn is the number average molecular weight. All individual values and subranges are disclosed and included herein. For example, the ethylene/alpha-olefin interpolymer may have an Mw/Mn of from 3.0 to 4.5 or 3.0 to 4.0.

In addition to density, melt index, and Mw/Mn, the ethylene/alpha-olefin interpolymer has a zero shear viscosity ratio (ZSVR) of 1.8 to 10.0. All individual values and subranges are included and disclosed herein. For example, the ethylene/alpha-olefin interpolymer composition may have a ZSVR that can be from 1.8 to 8.0, 1.8 to 6.5, or 2.0 to 5.0.

In addition to density, melt index, Mw/Mn, and ZSVR, the ethylene/alpha-olefin interpolymer may further be characterized by molecular weighted comonomer distribution index (MWCDI) of greater than −0.5 to 0.9. All individual values and subranges are included and disclosed herein. For example, the ethylene/alpha-olefin interpolymer composition may have a MWCDI that can be from −0.25 to 0.8 or 0 to 0.75.

Exemplary ethylene/alpha-olefin interpolymer resins may include, but are not limited to, polyethylene resins sold by The Dow Chemical Company, such as, ELITE™ 5100G, ELITE™ 5400G, DOWLEX™ 2045G, and ELITE™ AT 6101.

### Surfactant

In some embodiments, compositions suitable for making uncrosslinked low density polyethylene foam further comprise one or more surfactants. The surfactant can be added to the composition to enhance dimensional stability in the polyethylene foam product.

In some embodiments, the surfactant comprises one or more amides or esters of C₁₂-C₂₄ fatty acids, or partial esters of long chain fatty acids with polyols. Such surfactants are disclosed, for example, in U.S. Pat. Nos. 3,644,230 and 4,214,054, which are hereby incorporated by reference. Examples of such surfactants include stearyl stearamide, glycerol monostearate, glycerol monobehenate, glycerol distearate, glycerol monobenzoate, sorbitan monooleate, and sorbitol monostearate. In some embodiments, the composition comprises glycerol monostearate.

Such fatty acid-based surfactants can be included in an amount ranging from 0.1 to 5 parts per hundred parts of the composition suitable for making uncrosslinked low density polyethylene foam, or, in some embodiments, 0.5-1.5 weight percent based on the total weight of the composition.

### Antistatic Additives

In some embodiments, compositions suitable for making uncrosslinked low density polyethylene foam further comprise one or more antistatic additives. The antistatic additive can be added to the composition to reduce the potential generation of static electricity from the polyethylene foam product which may be useful, for example, in the packaging of electronics. Persons of ordinary skill in the art can select an appropriate commercially available antistatic additive for use in such embodiments based on the teachings herein.

Non-limiting examples of such antistatic additives include antistat masterbatches commercially available from Ampacet Corporation, antistatic additives commercially available from BASF under the name Irgastat, and antistatic additives commercially available from Croda International Plc under the name Atmer.

### Uncrosslinked Low Density Polyethylene Foam

As noted above, a polyethylene foam is formed from the polyethylene compositions described above.

In some embodiments, the polyethylene foam is an uncrosslinked polyethylene foam. The foam density of the uncrosslinked polyethylene foam ranges from 15 to 60 kg/m³. Minor amounts of other materials may also advantageously be used in the polyethylene compositions and/or the uncrosslinked polyethylene foams described herein. These include other polymers to provide added melt strength, foamability, stiffness (e.g., polypropylene), and pigments to provide coloring. These additional polymers should be present in an amount of 15 wt. % or less. In some embodiments, these additional polymers are present in amounts of 12.5 wt. % or less, 10 wt. % or less, 7.5 wt. % or less, or 5 wt. % or less. Process aids could also be added to help reduce shear heating, particularly when using lower melt index blends. Other additives such as UV stabilizers, chemical blowing agent, or fire retardants may be necessary to provide required functionality for specific applications, as is generally known in the art. The process aids and other additives should not be added in an amount greater than 2 percent (for example, less than 1.0 percent, less than 0.5 percent, or less than 0.1 percent) depending on the additive.

Embodiments of the present invention are particularly useful when isobutane is used as the blowing agent. The uncrosslinked polyethylene foam may be formed using a typical production line having a tandem extruder line set-up and with isobutane as the blowing agent. All components, including the polymer base resin, nucleating agent, permeation agent, and/or isobutane are mixed in a primary extruder to form a mixture. The mixture is transferred and cooled in a second extruder close to the crystallization temperature of the base resin. After release of the pressure in die lip, the blowing agent will expand at the nucleating agent center to form a cell. The die pressure and die gap can be varied to achieve different foam bubble structure and size. Extruder temperature may also be adjusted in order to melt the resins for mixture formation and sufficiently cool the mixture in the second extruder. It should be readily appreciated by one skilled in the art that the blend components and fabrication conditions (e.g., pressure and melt temperature in the extruders) can be chosen to optimize the chance of successfully making a foamed sheet as described herein. After the foam sheet was pulled out the die lip, typically it will need to be aged under ambient temperature for several days to sufficiently exchange the internal blowing agent with external air.

### Test Methods

### Melt Index

Melt index (I₂), for ethylene-based polymers, is measured in accordance with ASTM D 1238-10, Condition, 190° C./2.16 kg, and is reported in grams eluted per 10 minutes (g/10 minutes).

### Density

Samples for density measurement are prepared according to ASTM D 1928. Polymer samples are pressed at 190° C. and 30,000 psi (207 MPa) for three minutes, and then at 21° C. and 207 MPa for one minute. Measurements are made within one hour of sample pressing using ASTM D792, Method B.

### High Temperature Gel Permeation Chromatography (HT-GPC)

A PolymerChar (Valencia, Spain) high temperature Gel Permeation Chromatography system consisting of an infra-red concentration detector (IR-5) was used for MW and MWD determination. The solvent delivery pump, the on-line solvent degas device, auto-sampler, and column oven were from Agilent. The column compartment and detector compartment were operated at 150° C. The columns were three PLgel 10 μm Mixed-B, columns (Agilent). The carrier solvent was 1,2,4-trichlorobenzene (TCB) with a flow rate of 1.0 mL/min. Both solvent sources for chromatographic and sample preparation contained 250 ppm of butylated hydroxytoluene (BHT) and were nitrogen sparged. Polyethylene samples were prepared at targeted polymer concentrations of 2 mg/mL by dissolving in TCB at 160° C. for 3 hour on the auto-sampler just prior the injection. The injection volume was 200 μL.

Calibration of the GPC column set was performed with 21 narrow molecular weight distribution polystyrene standards. The molecular weights of the standards ranged from 580 to 8,400,000 g/mol, and were arranged in 6 “cocktail” mixtures, with at least a decade of separation between individual molecular weights. The polystyrene standard peak molecular weights were converted to polyethylene molecular weights using the following equation (as described in Williams and Ward, J. Polym. Sci., Polym. Let., 6, 621 (1968)):

M_{polyethylene}=A(M_{polystyrene})^{B} (1)

Here B has a value of 1.0, and the experimentally determined value of A is around 0.42. A third order polynomial was used to fit the respective polyethylene-equivalent calibration points obtained from equation (1) to their observed elution volumes. The actual polynomial fit was obtained so as to relate the logarithm of polyethylene equivalent molecular weights to the observed elution volumes (and associated powers) for each polystyrene standard. Number-, weight- and z-average molecular weights are calculated according to the following equations:

$$\begin{matrix}\overline{Mn} = \frac{{\sum }^{i} W {f}_{i}}{{\sum }^{i} ( W {f}_{i} / {M}_{i} )} & ( 2 ) \\ \overline{Mw} = \frac{{\sum }^{i} ( W {f}_{i} * {M}_{i} )}{{\sum }^{i} {Wf}_{i}} & ( 3 ) \\ \overline{Mz} = \frac{{\sum }^{i} ( W {f}_{i} * {M}_{i}^{2} )}{{\sum }^{i} ( W {f}_{i} * {M}_{i} )} & ( 4 )\end{matrix}$$

where, Wfᵢ is the weight fraction of the i-th component and Mᵢ is the molecular weight of the i-th component. The MWD is expressed as the ratio of the weight average molecular weight (Mw) to the number average molecular weight (Mn).

The accurate A value was determined by adjusting A value in equation (1) until Mw, the weight average molecular weight calculated using equation (3) and the corresponding retention volume polynomial, agreed with the independently determined value of Mw obtained in accordance with the linear homopolymer reference with known weight average molecular weight of 120,000 g/mol.

### Creep Zero Shear Viscosity Measurement Method

Zero-shear viscosities are obtained via creep tests that were conducted on an AR-G2 stress controlled rheometer (TA Instruments; New Castle, Del.) using 25-mm-diameter parallel plates at 190° C. The rheometer oven is set to test temperature for at least 30 minutes prior to zeroing fixtures. At the testing temperature a compression molded sample disk is inserted between the plates and allowed to come to equilibrium for 5 minutes. The upper plate is then lowered down to 50 μm above the desired testing gap (1.5 mm). Any superfluous material is trimmed off and the upper plate is lowered to the desired gap. Measurements are done under nitrogen purging at a flow rate of 5 L/min. Default creep time is set for 2 hours.

A constant low shear stress of 20 Pa is applied for all of the samples to ensure that the steady state shear rate is low enough to be in the Newtonian region. The resulting steady state shear rates are in the range of 10⁻³ to 10⁻⁴ s⁻¹ for the samples in this study. Steady state is determined by taking a linear regression for all the data in the last 10% time window of the plot of log (J(t)) vs. log(t), where J(t) is creep compliance and t is creep time.

If the slope of the linear regression is greater than 0.97, steady state is considered to be reached, then the creep test is stopped. In all cases in this study the slope meets the criterion within 2 hours. The steady state shear rate is determined from the slope of the linear regression of all of the data points in the last 10% time window of the plot of c vs. t, where c is strain. The zero-shear viscosity is determined from the ratio of the applied stress to the steady state shear rate.

In order to determine if the sample is degraded during the creep test, a small amplitude oscillatory shear test is conducted before and after the creep test on the same specimen from 0.1 to 100 rad/s. The complex viscosity values of the two tests are compared. If the difference of the viscosity values at 0.1 rad/s is greater than 5%, the sample is considered to have degraded during the creep test, and the result is discarded.

Zero-Shear Viscosity Ratio (ZSVR) is defined as the ratio of the zero-shear viscosity (ZSV) of the branched polyethylene material to the ZSV of the linear polyethylene material at the equivalent weight average molecular weight (Mw-gpc) according to the following Equation:

$$Z S V R = \frac{{η}_{0 B}}{{η}_{0 L}} = \frac{{η}_{0 B}}{2.2 {9}^{- 15} {M}_{w - gp c}^{3.65}}$$

The ZSV value is obtained from creep test at 190° C. via the method described above. The Mw-gpc value is determined by the HT-GPC method. The correlation between ZSV of linear polyethylene and its Mw-gpc was established based on a series of linear polyethylene reference materials. A description for the ZSV-Mw relationship can be found in the ANTEC proceeding: Karjala, Teresa P.; Sammler, Robert L.; Mangnus, Marc A.; Hazlitt, Lonnie G.; Johnson, Mark S.; Hagen, Charles M., Jr.; Huang, Joe W. L.; Reichek, Kenneth N. Detection of low levels of long-chain branching in polyolefins. Annual Technical Conference—Society of Plastics Engineers (2008), 66th 887-891.

### Molecular Weighted Comonomer Distribution Index (MWCDI)

A GPC-IR, high temperature chromatographic system from PolymerChar (Valencia, Spain) was equipped with a Precision Detectors' (Amherst, Mass.) 2-angle laser light scattering detector Model 2040, and an IR5 infra-red detector (GPC-IR) and a 4-capillary viscometer, both from PolymerChar. The “15-degree angle” of the light scattering detector was used for calculation purposes. Data collection was performed using PolymerChar Instrument Control software and data collection interface. The system was equipped with an on-line, solvent degas device and pumping system from Agilent Technologies (Santa Clara, Calif.).

Injection temperature was controlled at 150 degrees Celsius. The columns used, were four, 20-micron “Mixed-A” light scattering columns from Polymer Laboratories (Shropshire, UK). The solvent was 1,2,4-trichlorobenzene. The samples were prepared at a concentration of “0.1 grams of polymer in 50 milliliters of solvent.” The chromatographic solvent and the sample preparation solvent each contained “200 ppm of butylated hydroxytoluene (BHT).” Both solvent sources were nitrogen sparged. Ethylene-based polymer samples were stirred gently, at 160 degrees Celsius, for three hours. The injection volume was “200 microliters,” and the flow rate was “1 milliliters/minute.”

Calibration of the GPC column set was performed with 21 “narrow molecular weight distribution” polystyrene standards, with molecular weights ranging from 580 to 8,400,000 g/mole. These standards were arranged in six “cocktail” mixtures, with at least a decade of separation between individual molecular weights. The standards were purchased from Polymer Laboratories (Shropshire UK). The polystyrene standards were prepared at “0.025 grams in 50 milliliters of solvent” for molecular weights equal to, or greater than, 1,000,000 g/mole, and at “0.050 grams in 50 milliliters of solvent” for molecular weights less than 1,000,000 g/mole. The polystyrene standards were dissolved at 80 degrees Celsius, with gentle agitation, for 30 minutes. The narrow standards mixtures were run first, and in order of decreasing “highest molecular weight component,” to minimize degradation. The polystyrene standard peak molecular weights were converted to polyethylene molecular weights using Equation 1B (as described in Williams and Ward, J. Polym. Sci., Polym. Let., 6, 621 (1968)):

Mpolyethylene=A×(Mpolystyrene)^{B} (Eqn. 1B),

where M is the molecular weight, A has a value of approximately 0.40 and B is equal to 1.0. The A value was adjusted between 0.385 and 0.425 (depending upon specific column-set efficiency), such that NBS 1475A (NIST) linear polyethylene weight-average molecular weight corresponded to 52,000 g/mole, as calculated by Equation 3B, below:

$$\begin{matrix}Mn ( LALS gpc ) = \frac{{\sum }_{i = {RV}_{integration start}}^{i = {RV}_{integration end}} ( {IR}_{measurement {channel}_{i}} )}{{\sum }_{i = {RV}_{integration start}}^{i = {RV}_{integration end}} ( {IR}_{measurement {channel}_{i}} / {M}_{{PE}_{i}} )} & ( Eqn . 2 B ) \\ Mw ( LALS gpc ) = \frac{{\sum }_{i = {RV}_{integration start}}^{i = {RV}_{integration end}} ( {M}_{{PE}_{i}} {IR}_{measurement {channel}_{i}} )}{{\sum }_{i = {RV}_{integration start}}^{i = {RV}_{integration end}} ( {IR}_{measurement {channel}_{i}} )} & ( Eqn . 3 B )\end{matrix}$$

In Equations 2B and 3B, RV is column retention volume (linearly-spaced), collected at “1 point per second.” The IR is the baseline-subtracted IR detector signal, in Volts, from the measurement channel of the GPC instrument, and the M_{PE} is the polyethylene-equivalent MW determined from Equation 1B. Data calculation were performed using “GPC One software (version 2.013H)” from PolymerChar.

A calibration for the IR5 detector ratios was performed using at least ten ethylene-based polymer standards (polyethylene homopolymer and ethylene/octene copolymers; narrow molecular weight distribution and homogeneous comonomer distribution) of known short chain branching (SCB) frequency (measured by the ¹³C NMR Method, as discussed above), ranging from homopolymer (0 SCB/1000 total C) to approximately 50 SCB/1000 total C, where total C=carbons in backbone+carbons in branches. Each standard had a weight-average molecular weight from 36,000 g/mole to 126,000 g/mole, as determined by the GPC-LALS processing method described above. Each standard had a molecular weight distribution (Mw/Mn) from 2.0 to 2.5, as determined by the GPC-LALS processing method described above. Polymer properties for the SCB standards are shown in Table A.

TABLE A
“SCB” Standards

| Wt % | IR5 Area | SCB/1000 | | |
|---|---|---|---|---|
| Comonomer | ratio | Total C | Mw | Mw/Mn |
| 23.1 | 0.2411 | 28.9 | 37,300 | 2.22 |
| 14.0 | 0.2152 | 17.5 | 36,000 | 2.19 |
| 0.0 | 0.1809 | 0.0 | 38,400 | 2.20 |
| 35.9 | 0.2708 | 44.9 | 42,200 | 2.18 |
| 5.4 | 0.1959 | 6.8 | 37,400 | 2.16 |
| 8.6 | 0.2043 | 10.8 | 36,800 | 2.20 |
| 39.2 | 0.2770 | 49.0 | 125,600 | 2.22 |
| 1.1 | 0.1810 | 1.4 | 107,000 | 2.09 |
| 14.3 | 0.2161 | 17.9 | 103,600 | 2.20 |
| 9.4 | 0.2031 | 11.8 | 103,200 | 2.26 |

The “IR5 Area Ratio (or “IR5_{Methyl Channel Area}/IR5_{Measurement Channel Area}”)” of “the baseline-subtracted area response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) was calculated for each of the “SCB” standards. A linear fit of the SCB frequency versus the “IR5 Area Ratio” was constructed in the form of the following Equation 4B:

SCB/1000 total C=A₀+[A₁×(IR5_{Methyl Channel Area}/IR5_{Measurement Channel Area})] (Eqn. 4B),

where A₀ is the “SCB/1000 total C” intercept at an “IR5 Area Ratio” of zero, and A₁ is the slope of the “SCB/1000 total C” versus “IR5 Area Ratio” and represents the increase in the “SCB/1000 total C” as a function of “IR5 Area Ratio.”

A series of “linear baseline-subtracted chromatographic heights” for the chromatogram generated by the “IR5 methyl channel sensor” was established as a function of column elution volume, to generate a baseline-corrected chromatogram (methyl channel). A series of “linear baseline-subtracted chromatographic heights” for the chromatogram generated by the “IR5 measurement channel” was established as a function of column elution volume, to generate a base-line-corrected chromatogram (measurement channel). The “IR5 Height Ratio” of “the baseline-corrected chromatogram (methyl channel)” to “the baseline-corrected chromatogram (measurement channel)” was calculated at each column elution volume index (each equally-spaced index, representing 1 data point per second at 1 ml/min elution) across the sample integration bounds. The “IR5 Height Ratio” was multiplied by the coefficient A₁, and the coefficient A₀ was added to this result, to produce the predicted SCB frequency of the sample. The result was converted into mole percent comonomer, as follows in Equation 5B:

Mole Percent Comonomer={SCB_{f}/[SCB_{f}+((1000−SCB_{f}*Length of comonomer)/2)]}*100 (Eqn. 5B),

where “SCB_{f}” is the “SCB per 1000 total C” and the “Length of comonomer”=8 for octene, 6 for hexene, and so forth.

Each elution volume index was converted to a molecular weight value (Mwᵢ) using the method of Williams and Ward (described above; Eqn. 1B). The “Mole Percent Comonomer (y axis)” was plotted as a function of Log(Mwᵢ), and the slope was calculated between Mwᵢ of 15,000 and Mwᵢ of 150,000 g/mole (end group corrections on chain ends were omitted for this calculation). An EXCEL linear regression was used to calculate the slope between, and including, Mwᵢ from 15,000 to 150,000 g/mole. This slope is defined as the molecular weighted comonomer distribution index (MWCDI=Molecular Weighted Comonomer Distribution Index).

### Average Particle Size

The average particle size of the polytetrafluoroethylene is measured according to ASTM D4464.

### Foam Density

Foam density is measured according to ASTM D3575-14, Suffix W. This test method determines the density of the foam using the mass and volume of a regularly shaped specimen. For these measurements, each laminated sample has a thickness of ˜40 mm and a surface dimension of 100 mm×100 mm. The result in units of kg/m³ is obtained from measuring at least 3 samples and calculating the average.

### Average Cell Size

A foam sample is cut using a sharp knife and then stained with colored ink. The stained cross section is observed by optical microscopy with a magnification of seven. Three cross sections are observed and then corresponding images are taken for each foam sample. The maximum diameter of each cell is measured from the image of optical microscopy. The average cell size is obtained by averaging the measured maximum diameters of all cells in the images.

### Open Cell Content

The open cell content of a foam is measured using a Micromeritics AccuPyc 111340 gas pycnometer). The measurement is made in accordance with ASTM D6226-15. The air pressure used in the measurement is 0.5 psi. Two cubic samples (25 mm×25 mm×25 mm) are cut from the laminated specimens and used for the measurement.

### Compressive Strength

The compressive strength is measured using an INSTRON apparatus in accordance with ASTM D3575-14, Suffix D. A laminated specimen with a thickness of ˜40 mm and a surface dimension of 100 mm×100 mm is used. At least three specimens for each sample are measured. Each specimen is deflected (compressed) at a speed of 12.7 mm/min. The specimen is compressed from 0% to 80% of this thickness at 12.7 mm/min and the load reading is recorded immediately. The 25% compression deflection force per unit area of specimen, expressed as kilopascals, is then calculated.

### Thermal Insulation K-Factor

The thermal insulation K-factor of a foam is measured using an EKO-HC-074-200 thermal conductivity meter system. The measurement is in accordance with GBT 3399-1982.

Some embodiments of the invention will now be described in detail in the following Examples.

### EXAMPLES

The following materials are used in the Examples that follow.

TABLE 1

| | Description | Source |
|---|---|---|
| LDPE | Low density polyethylene | DOW ™ LDPE 450E |
| | polyethylene having a | from The Dow |
| | density of 0.923 g/cm³ and | Chemical Company |
| | a melt index (I₂) of 2.0 g/10 | |
| | minutes | |
| PTFE-1 | Masterbatch of 10% PTFE | AXELERON ™ CX |
| | (D50 = 10 microns) in a low | 0078 NT from The |
| | density polyethylene carrier | Dow Chemical |
| | | Company. |
| PTFE-2 | PTFE micronized powder | Algoflon L600 from |
| | (average particle size of 4 | Solvay Specialty |
| | microns) | Polymers |
| PTFE-3 | PTFE micronized powder | Polymist F5A from |
| | (D50 = 4 microns) | Solvay Specialty |
| | | Polymers |
| PTFE-4 | PTFE micronized powder | Polymist F5 A EX |
| | (D50 = 12 microns) | from Solvay Specialty |
| | | Polymers |
| PTFE-5 | Medium molecular weight | Polymist XPP 511 |
| | grade of micronized PTFE | from Solvay Specialty |
| | (average particle size of 20 | Polymers, D50 = 20 um |
| | microns) | |
| Talc-1 | Talc masterbatch for use as | Wuhu Huanbao |
| | EPE foaming nucleating | Masterbatch Company |
| | agent (50% solid content) | |
| Talc-2 | Talc masterbatch EPE foam | Shenzhen Beihua |
| | | Plastic Co., Ltd. |

The D50 values for the PTFE referenced in Table 1 reference the median diameter of the particle size distribution.

### Preparation of PTFE Masterbatch Compositions

A number of compositions for making uncrosslinked polyethylene foam utilizing the PTFE components are prepared as follows. For PTFE-1 (which is provided as a masterbatch of 10% PTFE in low density polyethylene), PTFE-1 is diluted using the LDPE (DOW™ LDPE 450E) in a twin screw extruder to provide a composition having a concentration of 1.0 weight percent PTFE. The twin screw extruder is operated at 250 rpm, at a flow rate of 25 kg/hour, and a barrel zone temperature of 180° C.

For compositions comprising PTFE-2, a masterbatch of 10 weight percent PTFE-2 in the LDPE is prepared, and then the masterbatch is diluted in a twin screw extruder using LDPE to provide a composition having 1.0 weight percent PTFE-2. The twin screw extruder is operated at 250 rpm, at a flow rate of 25 kg/hour, and a barrel zone temperature of 180° C. Compositions comprising the other PTFEs (PTFE-3, PTFE-4, and PTFE-5) are prepared in the same manner as PTFE-2 except that the final concentration of the PTFE in the compositions is 0.75 weight percent.

### Example 1

Foaming experiments are conducted in a single screw (120 mm screw diameter) extruder with a gas and butane permeability modifier injection system. The rotation speed of screw is fixed at 28 rpm. The temperature profile is listed in Table 2 below. Glycerol mono-stearate (GMS) is used as a butane permeability modifier. The GMS is first melted and then pumped into the melt of base resin DOW™ LDPE 450E before isobutane injection. The amount of GMS is 1.0 weight percent based on the total weight of the composition. The base resin (DOW™ LDPE 450E) and the specified PTFE Masterbatch Composition are first dry blended and then fed on the upstream end of the extruder. The amount of PTFE Masterbatch Composition blended with the LDPE depends on the target amount of PTFE to be included in the composition and is shown with the results in Table 3. The nominal thickness of each single foam sheet is around 5 mm. Several of the single foam sheets are hot-laminated into a multilayered foam plank having a nominal thickness of ˜40 mm.

TABLE 2

| | | | | | | | | | | | | |
|---|---|---|---|---|---|---|---|---|---|---|---|---|
| Zone | 1 | 2 | 3 | 4 | 5 | 6 | 7 | 8 | 9 | 10 | 11 | 12 |
| Temp. (° C.) | 160 | 185 | 185 | 185 | 170 | 128 | 88 | 88 | 88 | 88 | 88 | 90 |

The Average Cell Sizes, Open Cell Contents, and Compressive Strengths @ 25% Strain of the foams are measured as described above. The results are shown in Table 3:

TABLE 3

| | Amount of | | | | |
|---|---|---|---|---|---|
| | Nucleator | | Average | Open | Compressive |
| | (wt. % based | Foam | Cell | Cell | Strength @ |
| | on total weight | Density | Size | Content | 25% Strain |
| | of composition) | (kg/m³) | (mm) | (%) | (kPa) |
| Comparative | Talc-1 (2.0%) | 31.2 | 1.43 | 29.9 | 33.9 |
| Example A | | | | | |
| Comparative | PTFE-1 (0.2%) | 35.6 | — | — | — |
| Example B | | | | | |
| Inventive | PTFE-1 (0.1%) | 29.4 | 0.83 | 14.5 | 38.1 |
| Example 1 | | | | | |
| Inventive | PTFE-1 (0.08%) | 29.1 | 0.78 | 21.9 | 35.1 |
| Example 2 | | | | | |
| Inventive | PTFE-1 (0.05%) | 27.6 | 1.06 | 16.5 | 36.1 |
| Example 3 | | | | | |

The foam prepared using 2.0% Talc-1 (Comparative Example A) is commonly used in the industry. Comparative Example A has an average cell size of 1.43±0.23 mm. Comparatively, a much lower amount of PTFE-1 (Inventive Examples 1-3) significantly reduces the average cell size. For example, an average cell size of 0.83±0.21 mm is obtained when 0.1% PTFE-1 is used. These data show a much higher nucleation efficiency when PTFE-1 is used as a nucleating agent instead of the commonly used Talc-1.

In addition to the average cell size, the Inventive Examples have lower open-cell contents and higher compressive strengths than Comparative Example A. Further, if the difference in foam density is normalized ((ρ₁/ρ₂)^{1.5}), the foams prepared using PTFE-1 exhibit significantly higher compressive strengths than the foam prepared using Talc-1. While using PTFE-1, the amount used in Comparative Example B is higher than the Inventive Examples. The foams made using Comparative Example B exhibit obvious shrinkage of the extruded foams and poor surface appearance.

### Example 2

In this Example, the particle size of the PTFE used in the compositions for making uncrosslinked low density polyethylene foam are considered. Foams using the different nucleators are prepared in the same manner as described in Example 1. The Average Cell Sizes, Open Cell Contents, and Compressive Strengths @ 25% Strain of the foams are measured as described above. The results are shown in Table 4:

TABLE 4

| | Amount of | | | | |
|---|---|---|---|---|---|
| | Nucleator | | | | |
| | (wt. % based | | | | |
| | on total weight | | | Open | Compressive |
| | of composition; | Foam | Average | Cell | Strength @ |
| | average particle | Density | Cell Size | Content | 25% Strain |
| | size) | (kg/m³) | (mm) | (%) | (kPa) |
| Comparative | Talc-2 (0.6%) | 25.1 | 1.48 ± 0.28 | 20.2 | 35.8 |
| Example C | | | | | |
| Comparative | PTFE-3 | 24.6 | 1.58 ± 0.31 | 17.8 | 36.8 |
| Example D | (0.06%; 4 μm) | | | | |
| Inventive | PTFE-1 | 24.4 | 0.78 ± 0.13 | 16.4 | 39.0 |
| Example 4 | (0.06%; 10 μm) | | | | |
| Inventive | PTFE-4 | 23.4 | 0.88 ± 0.23 | 13.2 | 38.2 |
| Example 5 | (0.06%; 12 μm) | | | | |
| Comparative | PTFE-5 | 25.7 | 1.42 ± 0.31 | 26.5 | 35.2 |
| Example E | (0.06%; 20 μm) | | | | |

The results show that Inventive Examples 4 and 5, which utilized PTFE having average particle sizes of 10 microns and 12 microns, respectively, resulted in smaller average cell sizes than PTFE having a smaller average particle size (4 microns in Comparative Example D) and PTFE having a larger particle size (20 microns in Comparative Example E). In addition, a large PTFE particle size (20 microns in Comparative Example E) results in an increase of open cell content and a lower compressive strength.

In summary, Examples 1 and 2 show that compositions suitable for making uncrosslinked low density polyethylene foam, according to some embodiments of the present invention, having a relatively small amount of PTFE and an average particle size within a particular range can be used to make low density polyethylene foams having reduced cell size, low open cell content, and high compressive strength while at least maintaining low foam density.

### Example 3

In this Example, additional foams using Talc-1 and PTFE-1 are prepared in the same manner as described in Example 1. The Average Cell Sizes and Open Cell Contents are measured as described above. The results are shown in Table 5:

TABLE 5

| | Amount of | | | |
|---|---|---|---|---|
| | Nucleator | | | |
| | (wt. % based | | | |
| | on total weight | | | Open |
| | of composition; | Foam | Average | Cell |
| | average particle | Density | Cell Size | Content |
| | size) | (kg/m³) | (mm) | (%) |
| Comparative | Talc-1 (0.6%) | 26.5 | 1.3 | 20 |
| Example F | | | | |
| Inventive | PTFE-1 | 26.5 | 0.8 | 10 |
| Example 6 | (0.06%; 10 μm) | | | |

These results are consistent with those observed in connection with Example 1.

In addition, the Thermal Insulation K-factor values for the foams are measured. In addition to Comparative Example F and Inventive Example 6, Comparative Example G is also prepared. Comparative Example G is produced by extrusion lamination of the Comparative Example F foam with a 10 micron thick metal foil to improve the thermal resistance. The results of the K-factor testing are shown in Table 6, with the K-factor values being shown in units of mW/mK:

TABLE 6

| | K-factor (mW/mK) | | | |
|---|---|---|---|---|
| | Conditions | | | |
| | 2.5° C. | 12.5° C. | 22.5° C. | 32.5° C. |
| | Cold Plate: | Cold Plate: | Cold Plate: | Cold Plate: |
| | −10° C. | 0° C. | 10° C. | 20° C. |
| | Hot Plate: | Hot Plate: | Hot Plate: | Hot Plate: |
| | 15° C. | 25° C. | 35° C. | 45° C. |
| Comparative | 48.01 | 50.99 | 54.31 | 57.87 |
| Example F | | | | |
| Comparative | 45.85 | 48.67 | 51.72 | 54.95 |
| Example G | | | | |
| Inventive | 44.29 | 46.78 | 49.58 | 52.39 |
| Example 6 | | | | |

Inventive Example 6 utilizing PTFE, in addition to having a smaller cell size than the talc-based Comparative Example F, also possesses higher thermal resistance as compared to both Comparative Example F and the foam/foil laminate of Comparative Example G. This can advantageously allow converters to simplify structures for some end-uses by using a foam only structure to replace foam/foil laminates.

1. A composition suitable for making uncrosslinked low density polyethylene foam comprising:
at least 50 weight percent low density polyethylene based on the total weight of the composition, wherein the low density polyethylene has a density of 0.915 to 0.930 g/cm³ and a melt index (I₂) of 1 to 4 g/10 minutes; and
polytetrafluoroethylene having an average particle size of one micron to 15 microns.

2. The composition of claim 1, wherein the composition comprises 0.01 to 0.2 weight percent of the polytetrafluoroethylene based on the total weight of the composition.

3. The composition of claim 1, further comprising from 5 to less than 50 weight percent ethylene/alpha-olefin interpolymer having a density of 0.910-0.930 g/cm³ based on the total weight of the composition.

4. The composition of claim 1, further comprising stearyl stearamide, glycerol monostearate, glycerol monobehenate, glycerol distearate, glycerol monobenzoate, sorbitan monooleate, sorbitol monostearate, or a combination thereof.

5. An uncrosslinked low density polyethylene foam formed from a polyethylene composition, the composition comprising:
at least 50 weight percent low density polyethylene based on the total weight of the composition, wherein the low density polyethylene has a density of 0.915 to 0.930 g/cm³ and a melt index (I₂) of 1 to 4 g/10 minutes; and
polytetrafluoroethylene having an average particle size of one micron to 15 microns, wherein the foam density of the polyethylene foam is 15 to 60 kg/m³.

6. The foam of claim 5, wherein the foam has an average cell size of 1.2 mm or less.

7. The foam of claim 5, wherein the composition comprises 0.01 to 0.2 weight percent of the polytetrafluoroethylene based on the total weight of the composition.

8. The foam of claim 5, wherein the composition comprises from 5 to less than 50 weight percent ethylene/alpha-olefin interpolymer having a density of 0.910-0.930 g/cm³ based on the total weight of the composition.

9. The foam of claim 5, wherein the composition comprises stearyl stearamide, glycerol monostearate, glycerol monobehenate, glycerol distearate, glycerol monobenzoate, sorbitan monooleate, sorbitol monostearate, or a combination thereof.

10. A package comprising the foam of claim 5.
